(19) United States
(12) Patent Application Publication
(10) Pub. No.: US 2009/0049479 A1
(43) Pub. Date: Feb. 19, 2009

(54) USER INTERFACES TO PRESENT SHARED MEDIA

(75) Inventors: DAVID P. GREEN, Castaic, CA (US); Chris Roy, Los Angeles, CA (US); Eric J. Bennett, Los Angeles, CA (US); Tommi Iten, Redondo Beach, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., EL SEGUNDO, CA (US)

(21) Appl. No.: 11/840,177

(22) Filed: Aug. 16, 2007

(51) Int. Cl. G06F 3/00

(52) U.S. Cl. 725/46

(57) ABSTRACT

User interfaces to present shared media are described. An example includes a user interface for use with a media presentation system including a main page and a plurality of pages operatively linked to the main page; one or more interactive sections to present information associated with one or more media files, wherein the user interface integrates control over one or more presentations of media files of various formats from one or more media storage devices, and wherein the one or more media storage devices are peripheral devices in relation to the media presentation system.

### FIELD OF THE DISCLOSURE

The present disclosure relates generally to media presentation systems and, more particularly, to user interfaces to present shared media.

### BACKGROUND

Advancements in communication technology have led to enhanced media players (e.g., personal computers, digital video recorders, home media centers, game playing systems, etc.) and content delivery systems (e.g., broadband, satellite, digital cable, Internet, etc.). For example, every improvement in processing capability allows developers to provide additional functionality to a system. Such advancement also enables a single device or system to integrate control over several functions or operations that were previously performed by multiple devices or systems. The user interfaces that accompany these systems are also evolving.

### BRIEF DESCRIPTION OF THE DRAWINGS

FIG. 1 is a diagram of an example direct-to-home (DTH) transmission and reception system.

FIG. 2 illustrates an example manner of implementing the example integrated receiver/decoder (IRD) of FIG. 1.

FIG. 3 shows an example main page of an example user interface for a media file presentation system.

FIGS. 4A and 4B show a flow chart representing an example process that may be performed by a media file presentation system.

FIG. 5 shows an example screenshot of an example user interface for a music presentation feature.

FIG. 6 shows an example screenshot of an example user interface for a music presentation feature including a list of content.

FIG. 7 shows an example screenshot of an example user interface for a music presentation feature including the contents of an artist folder.

FIG. 8 shows an example screenshot of an example user interface for a music presentation feature including the contents of an album folder.

FIG. 9 shows an example screenshot of an example user interface for an image presentation feature.

FIG. 10 shows an example screenshot of an example user interface for an image presentation feature including the contents of an image folder.

FIG. 11 shows an example screenshot of an example user interface for a video presentation feature.

FIG. 12 shows an example screenshot of an example user interface for a video presentation feature including the contents of a video folder.

FIG. 13 illustrates an example manner of implementing an example processor unit.

### DETAILED DESCRIPTION

Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

Media may take many different forms such as audio, video, and/or photos or images. Media may also include one or more combinations of one or more types of media. For example, media may include one or more images or photos presented jointly with audio content. Another example may include video presented with audio (e.g., audio corresponding to the video content or separate audio played over the video content). In other words, media may include any form of audio and/or visual presentation including, for example, programming or programming content (e.g., a television program or broadcast). The example methods and apparatus described herein may be used to present media that may, for example, be stored on a media storage device in a media presentation system such as, for example, a home entertainment system including a media signal decoder (e.g., a set-top-box, a receiver, etc.) and a television, an audio system, or other media presentation device (e.g., a computer monitor and/or computer speakers). Moreover, the example interfaces described herein may be implemented to facilitate an interaction between such a media presentation system and a peripheral media storage device (e.g., a memory of a networked computer within a home) to present the contents of the peripheral device via the media presentation system (e.g., a television coupled to a set-top box).

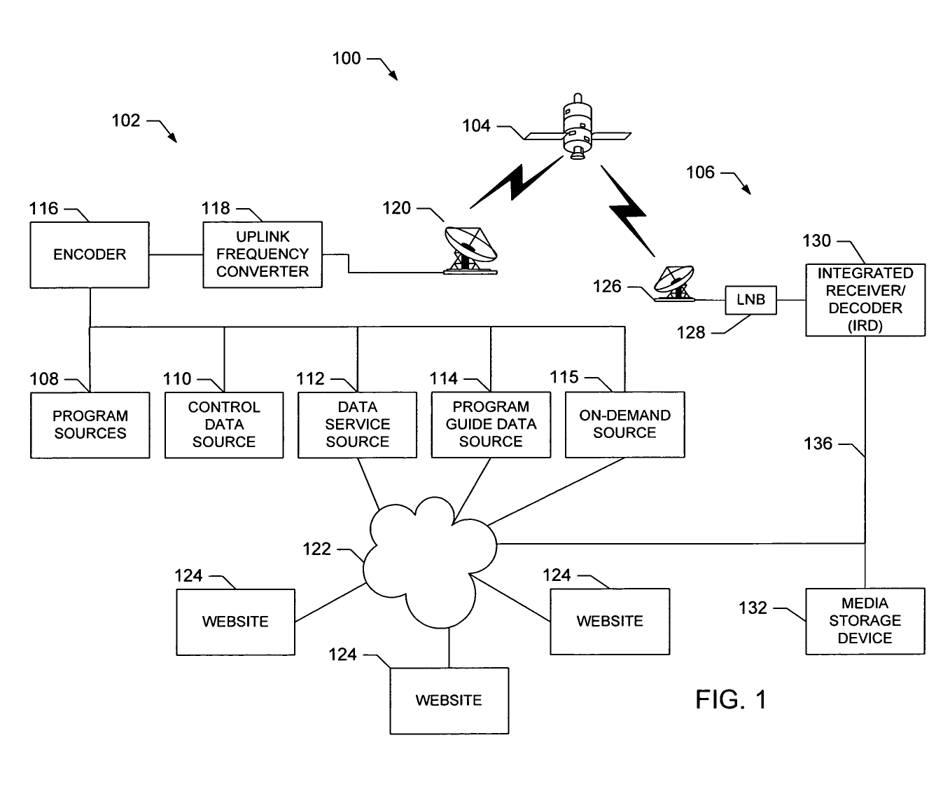

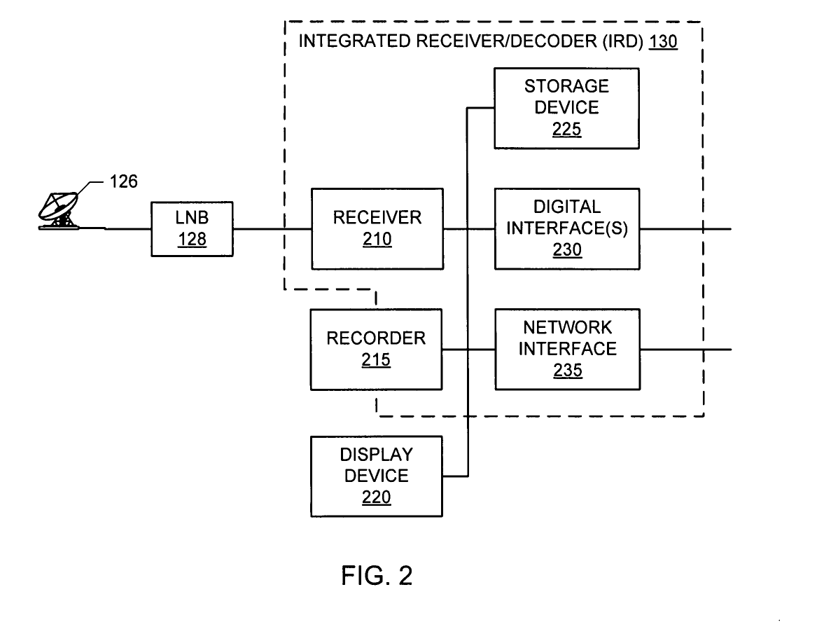

The example methods, apparatus, and interfaces described herein to present media may be implemented in connection with any type of media transmission system including, for example, satellite broadcast systems, cable broadcast systems, radio frequency wave broadcast systems, broadband transmission systems, etc. By way of illustration, an example broadcast system is described below in connection with FIG. 1 and an example receiver (e.g., a set-top-box, a broadcast signal decoder, etc.) is described in detail below in connection with FIG. 2. Further, while the following disclosure is made with respect to example DIRECTV® services and systems, it should be understood that many other delivery systems are readily applicable to the disclosed methods and apparatus. Such systems include wired or cable distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), and fiber optic networks.

As illustrated in FIG. 1, an example direct-to-home (DTH) system 100 generally includes a transmission station 102, a satellite/relay 104 and a plurality of receiver stations, one of which is shown at reference numeral 106, between which communications are exchanged. Wireless communications (e.g., via the satellite/relay 104) may take place at any suitable frequency, such as, for example, Ku-band frequencies. As described in detail below, information, such as media, from the transmission station 102 may be transmitted to the satellite/relay 104, which may be at least one geosynchronous or geo-stationary satellite that, in turn, rebroadcasts the information over broad geographical areas on the earth that include receiver stations 106. Further, the receiver stations 106 may be communicatively coupled to the transmission station 102 via a terrestrial communication link, such as a telephone line and/or an Internet connection 136 (e.g., a broadband connection).

In further detail, the example transmission station 102 of the example system of FIG. 1 includes a plurality of sources of data, media, and/or information including program sources 108, a control data source 110, a data service source 112, one or more program guide data sources 114, and an on-demand source 115. In an example operation, information and/or media (e.g., data representative of media) from one or more of these sources 108-115 passes to an encoder 116, which encodes the information and/or media for broadcast to the satellite/relay 104. Encoding includes, for example, converting the information into data streams that are multiplexed into a packetized data stream or bitstream using any of a variety of algorithms. A header is attached to each data packet within the packetized data stream to facilitate identification of the contents of the data packet. The header also includes a service channel identifier (SCID) that identifies the data packet. This data packet is then encrypted. As will be readily appreciated by those having ordinary skill in the art, a SCID is one particular example of a program identifier (PID).

To facilitate the broadcast of information such as media, the encoded information passes from the encoder 116 to an uplink frequency converter 118 that modulates a carrier wave with the encoded information and passes the modulated carrier wave to an uplink antenna 120, which broadcasts the information to the satellite/relay 104. Using any of a variety of techniques, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The satellite/relay 104 receives the modulated, encoded Ku-band bitstream and re-broadcasts it downward toward an area on earth that includes the receiver station 106. In the illustrated example of FIG. 1, the example receiver station 106 includes a reception antenna 126 connected to a low-noise-block (LNB) 128 that is further connected to an integrated receiver/decoder (IRD) 130. The IRD 130 may be a set-top box, a personal computer (PC) having a receiver card installed therein, or any other suitable device.

In operation of the receiver station 106, the reception antenna 126 receives signals including a bitstream from the satellite/relay 104. The signals are coupled from the reception antenna 126 to the LNB 128, which amplifies and, optionally, downconverts the received signals. The LNB output is then provided to the IRD 130.

The receiver station 106 may also incorporate a connection 136 (e.g., Ethernet circuit or modem for communicating over the Internet) to the network 122 for transmitting requests for information and/or media and/or other data back to and from the transmission station 102 (or a device managing the transmission station 102 and overall flow of data in the example system 100) and for communicating with websites 124 to obtain information therefrom. For example, as discussed further below, the IRD 130 may acquire and decode on-demand content and/or information associated with on-demand content from the on-demand source 115 via the connection 136 (e.g., a broadband Internet connection). Further, the IRD 130 may coupled to an external media storage device 132 (e.g., a hard drive of a personal computer in a home along with the IRD 130 or a computer connected over a network or other communication means). As described below, media files (e.g., music or images) stored on the media storage device 132 may be shared with the IRD 130 and presented on a display device (e.g., the display device 220 of FIG. 2).

The programming sources 108 receive video and/or audio programming (e.g., various forms of media) from a number of sources, including satellites, terrestrial fiber optics, cable, or tape. The programming may include, but is not limited to, television programming, movies, sporting events, news, music or any other desirable content. Like the programming sources 108, the control data source 110 passes control data to the encoder 116. Control data may include data representative of a list of SCIDs to be used during the encoding process, or any other suitable information.

The data service source 112 receives data service information and web pages made up of text files, graphics, audio, video, software, etc. Such information may be provided via a network 122. In practice, the network 122 may be the Internet, a local area network (LAN), a wide area network (WAN) or a conventional public switched telephone network (PSTN). The information received from various sources is compiled by the data service source 112 and provided to the encoder 116. For example, the data service source 112 may request and receive information from one or more websites 124. The information from the websites 124 may be related to the program information provided to the encoder 116 by the program sources 108, thereby providing additional data related to programming content that may be displayed to a user at the receiver station 106.

The program guide data source 114 compiles information related to the SCIDs used by the encoder 116 to encode the data that is broadcast. For example, the program guide data source 114 includes information that the receiver stations 106 use to generate and display a program guide to a user, wherein the program guide may be configured as a grid that informs the user of particular programs that are available on particular channels at particular times. Such a program guide may also include information that the receiver stations 106 use to assemble programming for display to the user. For example, if the user desires to watch media such as a baseball game on his or her receiver station 106, the user will tune to a channel on which the game is offered. The receiver station 106 gathers the SCIDs related to the game, wherein the program guide data source 114 has previously provided to the receiver station 106 a list of SCIDs that correspond to the game. Such a program guide may be manipulated via an input device (e.g., an remote control). For example, a cursor may be moved to highlight a program description within the guide. A user may then select a highlighted program description via the input device to navigate to associated content (e.g., an information screen containing a summary of a television program).

The on-demand (OD) source 115 receives data representative of content or media from a plurality of sources, including, for example, television broadcasting networks, cable networks, system administrators (e.g., providers of the DTH system 100), or other content distributors. Such content (e.g., media) may include television programs, sporting events, movies, music, and corresponding information (e.g., user interface information for OD content) for each program or event. The content may be stored (e.g., on a server) at the transmission station 102 or locally (e.g., at a receiver station 106), and may be updated to include, for example, new episodes of television programs, recently released movies, and/or current advertisements for such content. Via a user interface, which also may be updated periodically to reflect current time or offerings, a user (e.g., a person with a subscription to an OD service) may request (i.e., demand) programming from the OD source 115. The system 100 may then stream the requested content to the user (e.g., over a broadband Internet connection) or make it available for download and storage. Thus, an OD service allows a user to view, download, and/or record selected programming at any time. While the acquisition of such content may involve a delay, the term ‘on-demand’ generally refers to a service that allows a user to request and subsequently receive media content. In other words, while on-demand content may not be immediately available, it includes content that may be requested for transmission (e.g., over a broadband Internet connection or via a satellite), download, and/or storage.

FIG. 2 illustrates one example manner of implementing the IRD 130 (e.g., a set-top box) of FIG. 1. The IRD 130 of FIG. 2 is merely an example and other IRD implementations are possible. The LNB output is provided to a receiver 210, which receives, demodulates, de-packetizes, de-multiplexes, decrypts and/or decodes the received signal to provide audio and video signals (e.g., media) to a display device 220 (e.g., a television set or computer monitor) and/or a recorder 215. The receiver 210 is responsive to user inputs to, for example, tune to a particular program or media.

As illustrated in FIG. 2, the recorder 215 may be implemented separately from and/or within the IRD 130. The recorder 215 may be, for example, a device capable of recording information on a storage device 225 (e.g., analog media such as videotape, or computer readable digital media such as a hard disk drive, a digital versatile disc (DVD), a compact disc (CD), flash memory, and/or any other suitable media). The storage device 225 is used to store the packetized assets and/or programs (e.g., a movie requested and transmitted from the OD source 115 over a broadband Internet connection). In particular, the packets stored on the storage device 225 are the same encoded and, optionally, encrypted packets created by the transmission station 102 and transmitted via the satellite/relay 104 or the connection 136.

To communicate with any of a variety of clients, media players, media storage devices, etc., the example IRD 130 includes one or more digital interfaces 230 (e.g., USB, serial port, Firewire, etc.). To communicatively couple the example IRD 130 to, for example, the Internet and/or a home network, the example IRD 130 includes a network interface 235 that implements, for example, an Ethernet interface.

The example IRD 130 is only one example implementation of a device that may be used to carry out the functionality described herein. Similar systems may include additional or alternative components (e.g., decoders, encoders, converters, graphics accelerators, etc.).

Having described the architecture of one example system that may be used to implement a user interface to present shared media, an example process for performing the same is described below. Although the following discloses an example process through the use of a flow diagram having blocks, it should be noted that the process may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. For example, instructions representing some or all of the blocks shown in the flow diagrams may be stored in one or more memories or other machine readable media, such as hard drives or the like. Such instructions may be hard coded or may be alterable. Additionally, some portions of the process may be carried out manually. Furthermore, while each of the processes described herein is shown in a particular order, such an ordering is merely one example and numerous other orders exist.

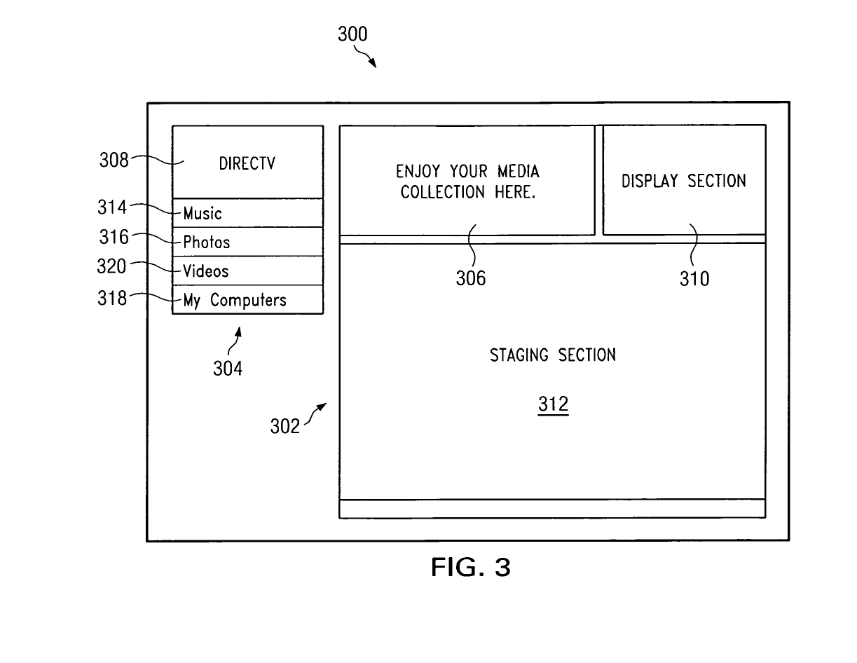

As described above, a user interface may be provided to facilitate an interaction between a user and a media presentation system. For example, to allow the utilization or navigation of the content stored on a media storage device (e.g., the media storage device 132 of FIG. 1) via a presentation device (e.g., the IRD 130 of FIG. 1), a media presentation system may include an on-screen guide and/or menu to be manipulated through the use of a remote control or other suitable input device by a user. A portion of such an example user interface 300 is illustrated in FIG. 3. More specifically, FIG. 3 shows an example main page 302 of the user interface 300 that may be displayed upon an access or activation of a media file presentation feature. As illustrated in FIG. 3, the example main page 302 includes a menu 304, an information section 306, a source indicator 308, a display section 310, and a staging section 312.

As indicated by the segments (i.e., the ‘Music,’ ‘Photos,’ ‘Videos,’ and ‘My Computers’ categories) of the menu 304, the example user interface 300 allows a user to navigate through and access media such as music, image, and/or video content from, for example, one or more computers. Other example user interfaces may include additional options to access further types of media. As described below, categories or other values may be selected from the menu 304 to facilitate navigation through the menu 304 and to alter the contents of the menu 304 itself and/or the contents of the staging section 312.

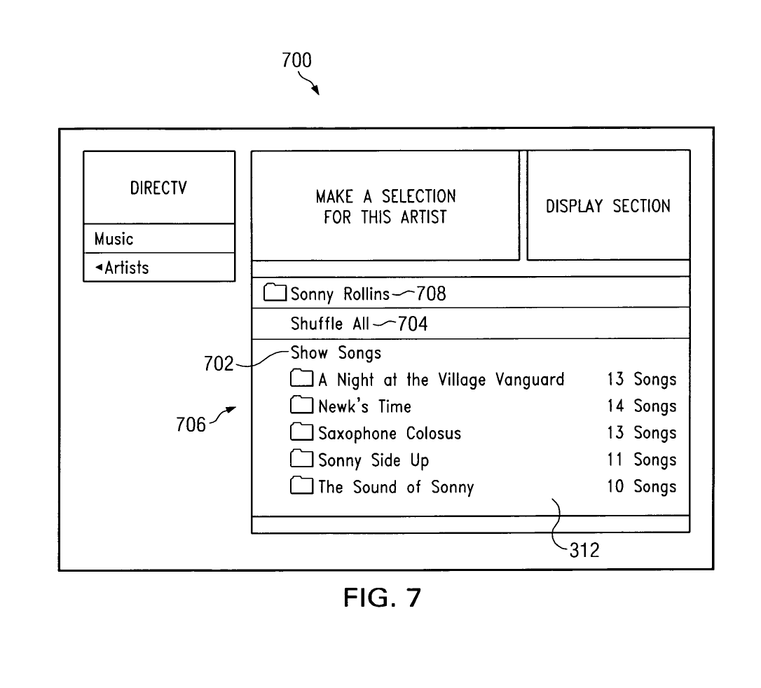

The information section 306 may include information, questions, and/or instructions regarding the use of the media file presentation system. For example, the information section 306 may prompt a user to select a song from a list (as illustrated in FIG. 7). Alternatively, the information section 306 may include an artist name, an album title, a date of the creation of a photograph, a description of a photograph, a summary of a video, etc. The contents of the information section 306 may change upon a highlighting (e.g., via a cursor) or selection of a new section, category, and/or graphic.

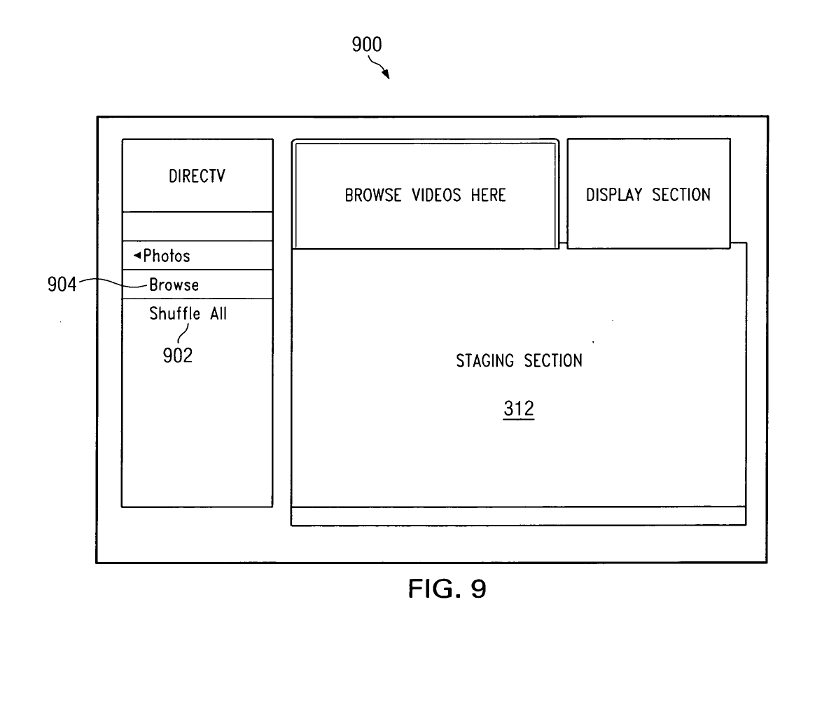

The display section 310 may include, for example, a display of the channel to which the system is currently tuned, or may include a recording currently being played back, a music file currently being played, a slideshow of images currently being presented, and/or a playback of a video from a peripheral media storage device. Additionally or alternatively, the display section 310 may include media information such as information related to a currently tuned channel or programming content. The display section 310 allows a user to continue to view and/or listen to media while navigating through the user interface 300. For example, if a user is viewing a live television broadcast, the display section 310 may display the broadcast while a user parses through a list of songs stored on a media storage device (e.g., the media storage device 132 of FIG. 1) via the user interface 300. In another example, if a slideshow (e.g., a series of photographs as described below in connection with FIG. 9) is currently being presented back and a user accesses the user interface 300, the display section 310 may continue to present the slideshow, allowing the user to simultaneously utilize the user interface 300 and watch the slideshow. In cases in which a slideshow is being presented on a full-screen display, a user may activate or access the user interface 300, select a ‘Music’ option and select a song (e.g., via the methods described herein), and play the song, all while the slideshow is being presented. Thus, the user interface 300 integrates control over one or more presentations of media files of various formats and, in some examples, control over simultaneous presentations of media files of various formats.

The staging section 312 may be responsive to user selections made in the menu 304 and, as illustrated in the following figures, provides a display of available content from a peripheral (i.e., in relation to the media presentation system) media storage device (e.g., a computer coupled to a set-top box). The staging section 312 may include a textual or graphical representation of the contents of such a media storage device. A cursor may be maneuvered via an input device (e.g., an infrared or radio frequency (RF) remote control) over the contents of the staging section 312 to select a media file for presentation or to view information regarding the file. A selection of a file (e.g., via a textual or pictorial graphic associated with the file) may cause the media presentation system to exit the user interface 300 and return to a main display (e.g., a full-screen presentation mode), where the selected media file may be presented (e.g., a music file may be played or an image or video may be displayed).

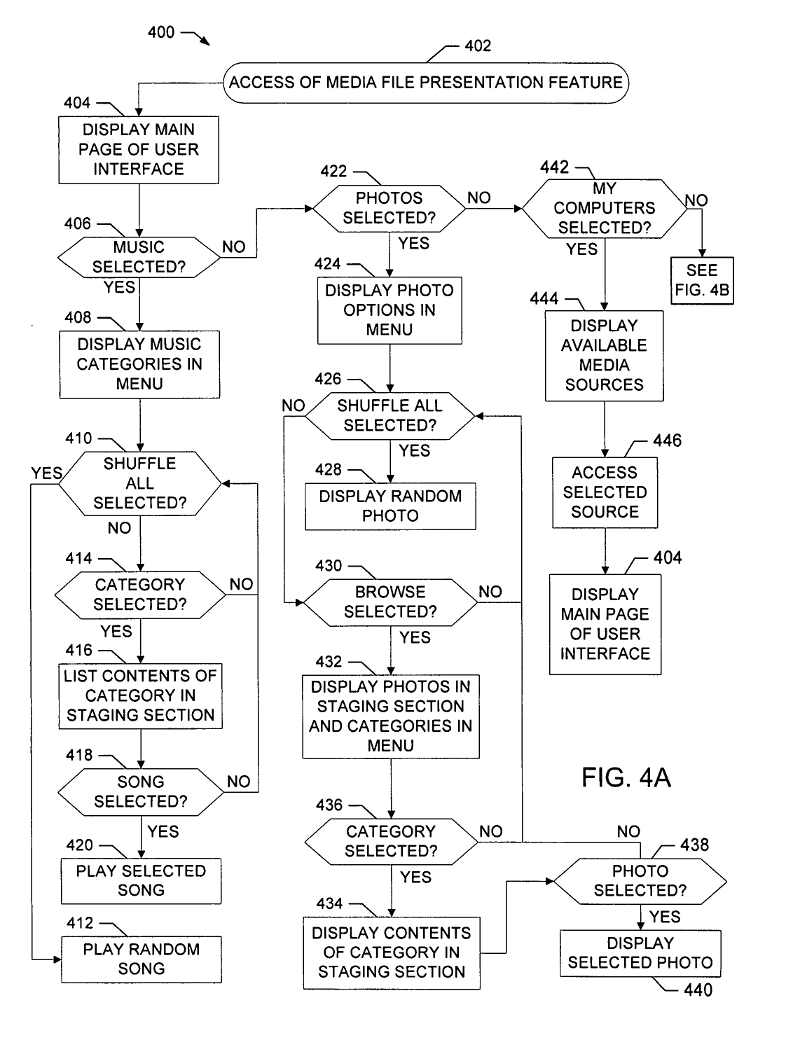

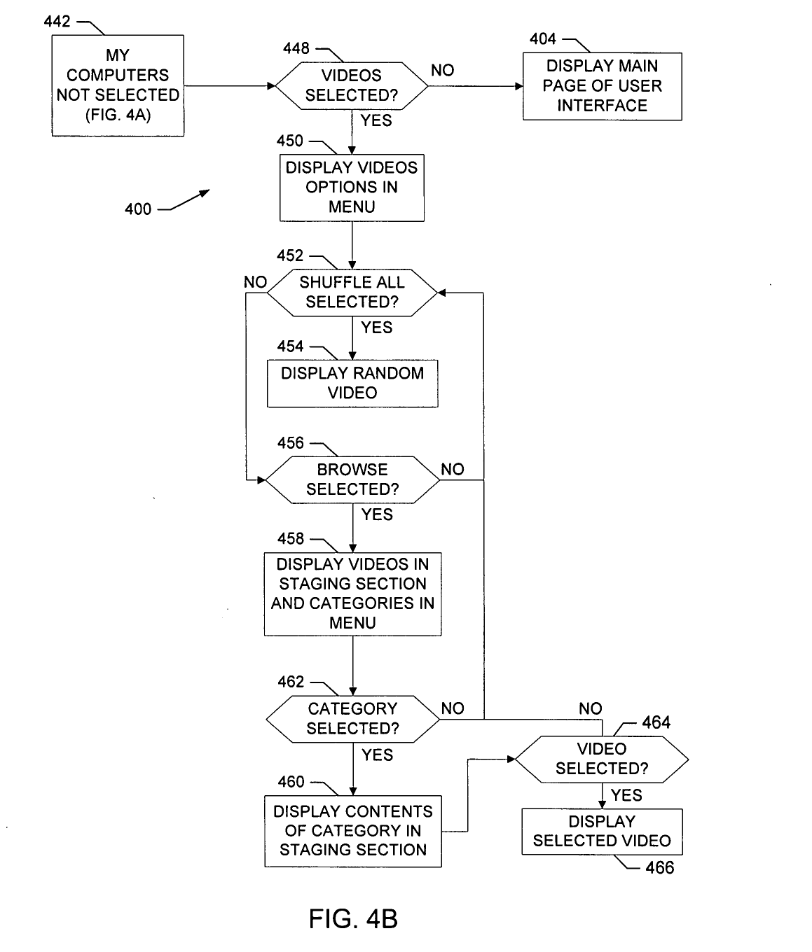

FIGS. 4 and 4A show a flow chart representing an example process 400 that may be performed by a media file presentation system implementing the user interface of FIG. 3. As noted above, the process may be implemented using, for example, machine or computer readable instructions and/or hardware and/or software. When the media file presentation system is accessed or activated (e.g., by engaging a designated button on a remote control or an on-screen button) (block 402), the main page 302 may be presented (block 404). The display section 310 may, for example, present the content (e.g., a television broadcast, a photograph, a slideshow of photographs, videos, etc.) being presented prior to the activation of the media file presentation system.

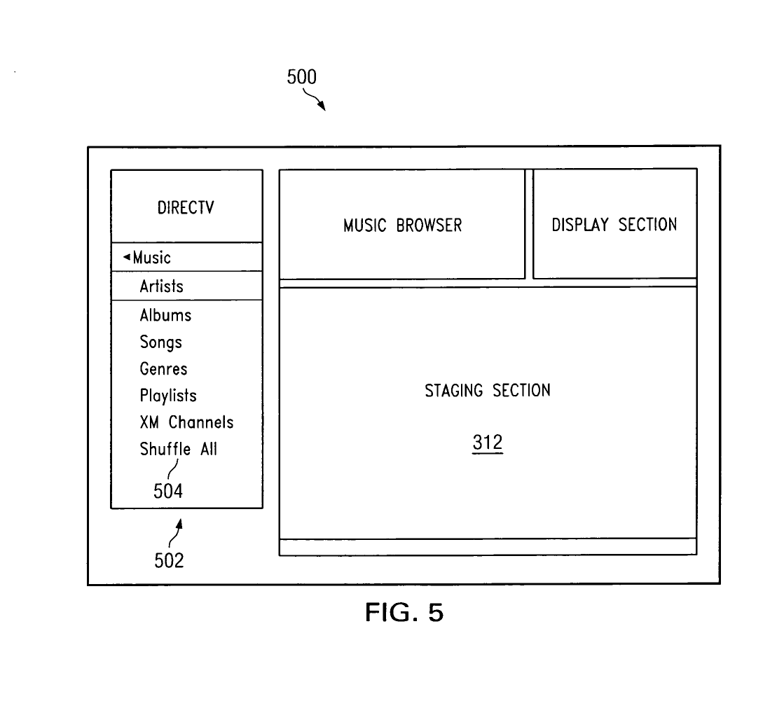

The process 400 may determine which, if any, option from the menu 304 was selected. A selection of a ‘Music’ option 314 (block 406), for example, may cause the process 400 to display a set of music categories in the menu 304 (block 408). FIG. 5 shows a screenshot 500 of the user interface 300 when a user has selected the ‘Music’ option 314 from the main page 302. Specifically, the menu 304 includes a plurality of categories 502 into which music (e.g., audio data stored on the media storage device 132 of FIG. 1) may be sorted. As shown in FIG. 5, the plurality of categories 502 may be listed in a staggered position below the selected feature (e.g., the ‘Music’ option 314). The categories listed in FIG. 5 are for illustrative purposes and other examples may include additional or alternative categories. The selection of the ‘Music’ option 314 alters the menu 304, but may not alter the content of the staging section 312. In others words, the menu 304 and the staging section 312 may operate separately or in congruence in response to user commands.

Further, a ‘Shuffle All’ option 504 may be included in the menu 304. The selection of the ‘Shuffle All’ option 504 (block 410) may prompt the playing of a randomly chosen song or a continuous string of randomly chosen songs (block 412). On the other hand, when a category is chosen (block 414), the contents of the category are displaying in the staging section 312 (block 416).

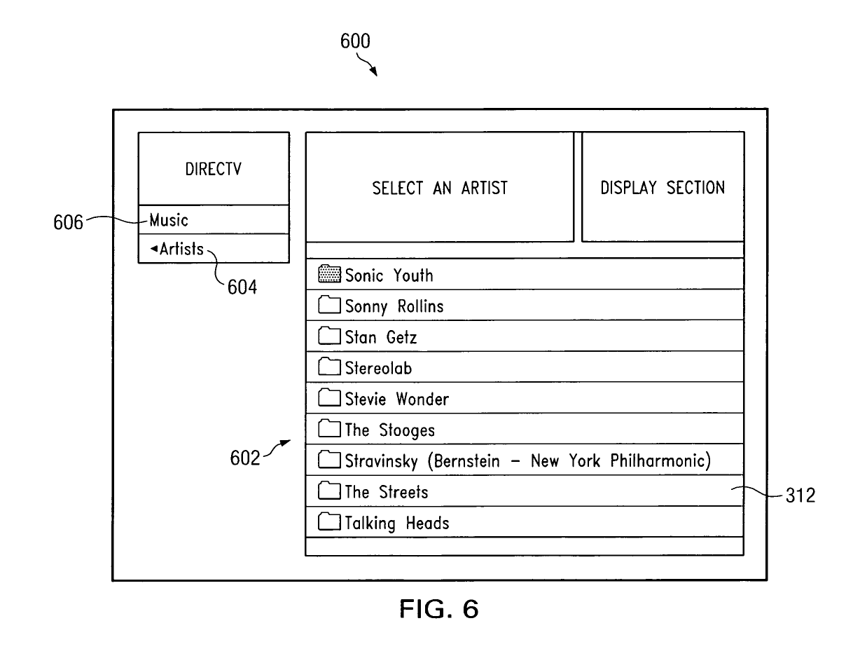

FIG. 6 shows a screenshot 600 of the user interface 300 when a user has selected a music category. Specifically, a list 602 of the contents of the chosen category 604 (‘Artists’ in FIG. 6) may be displayed in the staging section 312. The contents may be listed alphabetically, chronologically, or in any other suitable arrangement. The media presentation system may include a default setting (e.g., alphabetical) for the arrangement of the contents that may be changeable by a user. Further, the menu 304 may be altered to indicate which category 604 is displayed in the staging section 312. To return to a previous screen (e.g., the screen 500 illustrated in FIG. 5) a user may select the chosen category 604 or the general option,606 under which the category 604 is included.

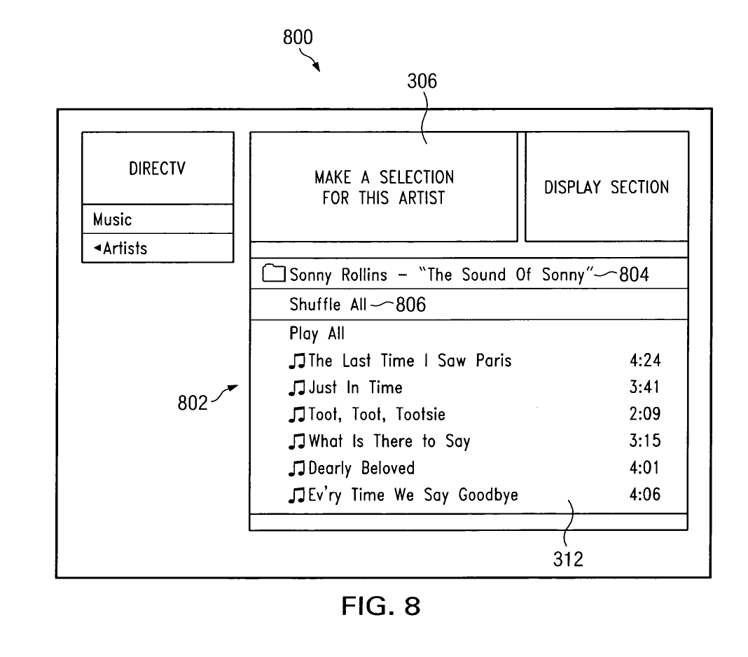

Additionally, each entry of the list 602 may have multiple layers or subcategories into which the music data may be organized or sorted. The layers or subcategories may be displayed in a staggered arrangement (i.e., to reflect the organization of the content on the media storage device) upon the selection of an entry of the list 602. For example, FIG. 7 shows a screenshot 700 of the user interface 300 when a user has selected an entry from the list 602. Here, the staging section 312 includes a ‘Show Songs’ option 702, a ‘Shuffle All’ option 704, and a plurality of albums 706 of the chosen artist 708. A selection of the ‘Shuffle All’ option 704 may cause the user interface 300 to present one or more randomly chosen songs from the selected artist 708 (or other selected category). A selection of the ‘Show Songs’ option 702 may cause the user interface 300 to display all of the songs by the chosen artist 708 in the staging section 312. A selection of one of the plurality of albums 706 may cause the user interface 300 to display the songs included in that album in the staging section 312. For example, FIG. 8 shows a screenshot 800 of the user interface 300 when a user has selected an album from the plurality of albums 706 of FIG. 7. A list 802 of the contents of the chosen album 804 is displayed in the staging section 312. Further, the information section 306 may include information regarding a highlighted or selected song (not shown) or set of instructions.

Returning to the flowchart of FIG. 4, when a song is selected (e.g., from the list 802) (block 418), the media presentation system presents the selected song (block 420) and, perhaps, returns to a main display (i.e., a full-screen display that includes information and/or playback options for the song being played). As described above, the process 400 may also detect the selection of a ‘Shuffle All’ option (block 410), thereby causing the media presentation system to present a random song or a continuous string of random songs (block 412). If the ‘Shuffle All’ option is selected in a position staggered under a category (e.g., the ‘Shuffle All’ option 704 of FIG. 7 or the ‘Shuffle All’ option 804 of FIG. 8), the media presentation system may present a random song or string of songs from within the category under which the selected ‘Shuffle All’ is positioned.

A selection of a ‘Photos’ option 316 (block 422) from the main page 302 may cause the process 400 to display a set of options in the menu 304 (block 424). FIG. 9 shows a screenshot 900 of the user interface 300 when a user has selected a ‘Photos’ option 316 from the main page 302. Specifically, in this example, the menu 304 includes a ‘Shuffle All’ option 902 and a ‘Browse’ option 904. When the ‘Shuffle All’ option 902 is selected (block 426) a random photo or a string of continuous photos (i.e., a slideshow) from a media storage device (e.g., the media storage device 132 of FIG. 1) may be presented by the media presentation system (e.g., via the display device 220 of FIG. 2) (block 428).

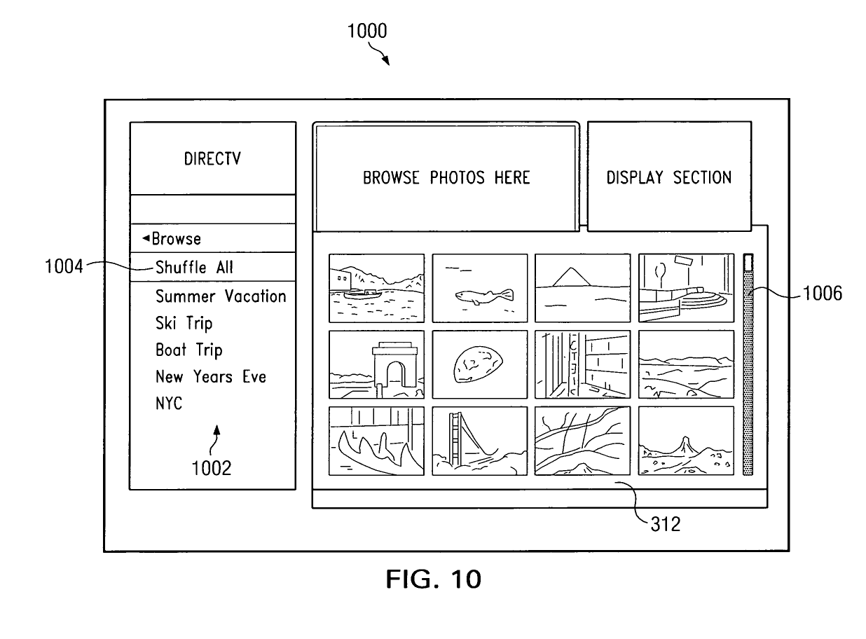

On the other hand, when the ‘Browse’ option 904 is selected (block 430), one or more photograph categories may be listed in the menu 304 and/or one or more photographs (or graphics linked to the photographs) may be displayed in the staging section 312 (block 432). FIG. 10 shows a screenshot 1000 of the user interface 300 when a user has selected the ‘Browse’ option 904. A plurality of categories 1002 may be listed in a staggered position below the selected feature (e.g., the ‘Browse’ option 904). The categories listed in FIG. 1000 are for illustrative purposes and other example pages may include additional or alternative categories. The plurality of categories 1002 is representative of the organization of the content stored on the media storage device. Further, the initial display of images in the staging section 312 may include every photograph stored on the media storage device, commonly accessed photographs, currently accessed photographs, etc. As a category is highlighted in the menu 304, the photographs displayed in the staging section 314 may change to correspond to the highlighted category. Alternatively, the photographs displayed in the staging section 312 may change (block 434) upon the selection of a category (block 436) from the menu 304. A user may scroll through the contents of the staging section 312 (e.g., via a scroll bar 1006) to review the content. Further, a ‘Shuffle All’ option 1004 may be selected to display a random photograph or a string of continuous photographs (i.e., a slideshow). When a photograph is selected (e.g., by engaging a designated button while a graphic or photograph is highlighted in the staging section) (block 438), the media presentation system may display the photograph (e.g., on the display device 220 of FIG. 2 in a full-screen mode) (block 440). Additionally or alternatively, the selection of a photograph or an associated graphic from the staging section 312 may cause the media presentation system to begin displaying a series of photographs (e.g., a slideshow of each photograph from the category to which the selected photograph belongs).

A selection of a ‘My Computers’ option 318 (block 442) from the main page 302 may cause the process 400 to display a list (not shown) of available media sources (block 444) in the menu 304 or the staging section 312. When a media source is selected, the process 400 may access the selected source (e.g., to prepare the user interface 300 with the contents of the selected media source) (block 446). The process 400 may then return the user interface 300 to the main page 302 (block 404).

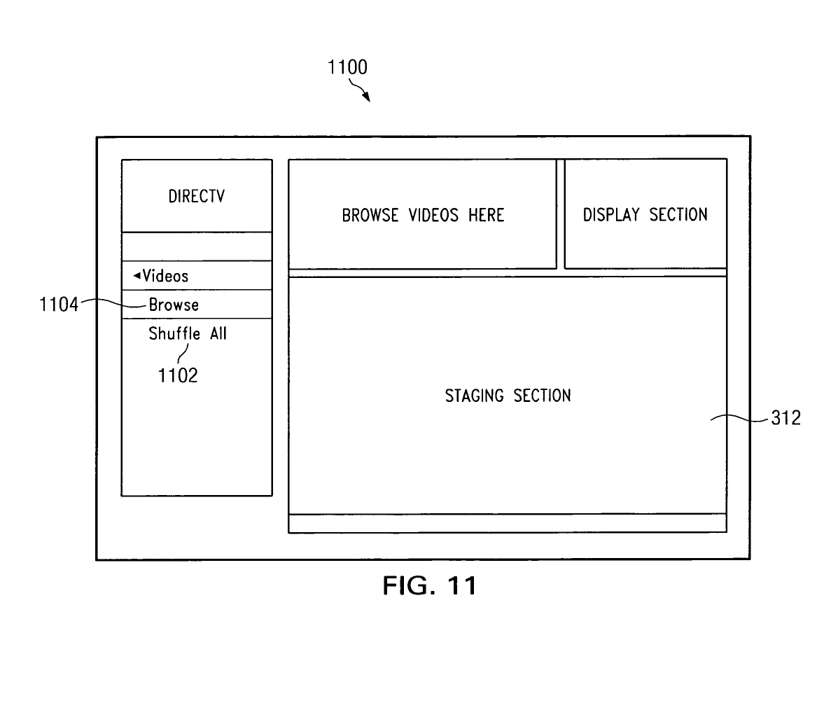

A selection of a ‘Videos’ option 318 (block 448) from the main page 302 may cause the process 400 to display a set of options in the menu 304 (block 450). FIG. 11 shows a screenshot 1100 of the user interface 300 when a user has selected a ‘Videos’ option 316 from the main page 302. Specifically, in this example, the menu 304 includes a ‘Shuffle All’ option 1102 and a ‘Browse’ option 1104. When the ‘Shuffle All’ option 1102 is selected (block 452) a random video or a string of continuous videos from a media storage device (e.g., the media storage device 132 of FIG. 1) may be presented by the media presentation system (e.g., via the display device 220 of FIG. 2) (block 454).

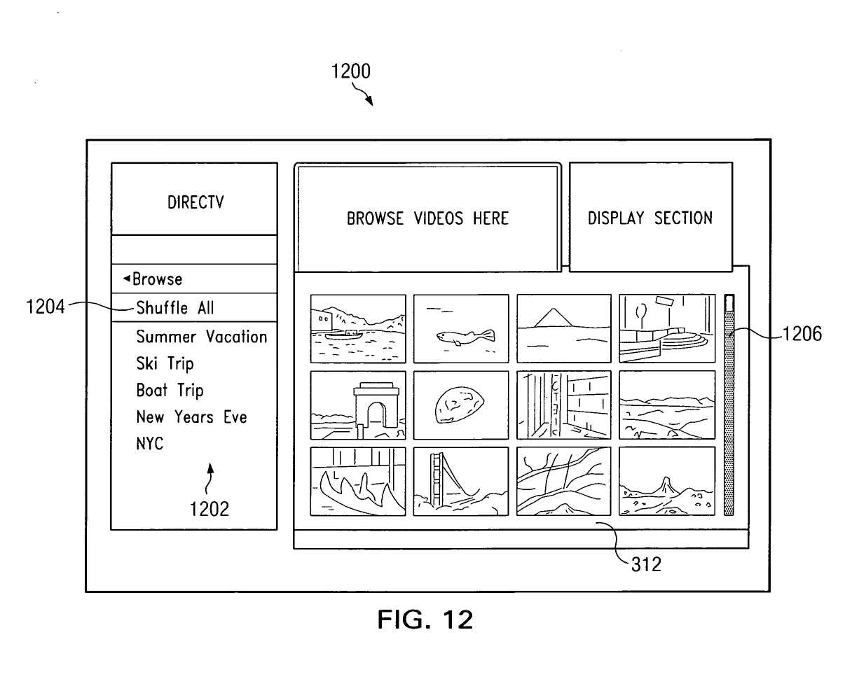

On the other hand, when the ‘Browse’ option 1104 is selected (block 456), one or more video categories may be listed in the menu 304 and/or one or more images (i.e., graphics linked to the video) may be displayed in the staging section 312 (block 458). FIG. 12 shows a screenshot 1200 of the user interface 300 when a user has selected the ‘Browse’ option 1104. A plurality of categories 1202 may be listed in a staggered position below the selected feature (e.g., the ‘Browse’ option 1104). The categories listed in FIG. 1200 are for illustrative purposes and other example pages may include additional or alternative categories. The plurality of categories 1202 is representative of the organization of the content stored on the media storage device. Further, the initial display of images in the staging section 312 may include a representation of every video stored on the media storage device, commonly accessed videos, currently accessed videos, etc. As a category is highlighted in the menu 304, the videos displayed in the staging section 314 may change to correspond to the highlighted category. Alternatively, the videos displayed in the staging section 312 may change (block 460) upon the selection of a category (block 462) from the menu 304. A user may scroll through the contents of the staging section 312 (e.g., via a scroll bar 1206) to review the content. Further, a ‘Shuffle All’ option 1204 may be selected to display a random video or a string of continuous videos. When a video is selected (e.g., by engaging a designated button while a graphic linked to the video is highlighted in the staging section) (block 464), the media presentation system may display the video (e.g., on the display device 220 of FIG. 2 in a fill-screen mode) (block 466). Additionally or alternatively, the selection of a video or an associated graphic from the staging section 312 may cause the media presentation system to begin displaying a series of videos of the category from which the video was selected.

The example process 400 described above is one possible implementation of the example user interface 300. The process 400 and the user interface 300 may include additional and/or alternative features or aspects to facilitate an interaction between a user and a media presentation system to present shared media. Further, while the example user interface 300 and the example process 400 include features to present media such as music, video, and images (e.g., mp3 files, digital images, etc.), other types of media may be included in other example user interfaces and/or processes.

Additionally, the example user interfaces described herein may facilitate a paired media feature. A paired media feature may allow a media presentation system to present, for example, a slideshow selected from a media storage device (e.g., the media storage device 132 of FIG. 1) simultaneously with music selected from the same or separate media storage device. Where only one type of media is being presented, the user may be prompted with a request asking if the user wants to present another type of media concurrently. Further, the user interfaces described herein allow separate types of media (e.g., music, video, and/or images) to be accessed and controlled from the same interface. For example, while music is being played, a user may activate the user interface 300, select the ‘Photos’ option 316, navigate through the photographic content as described above, and select a photograph that is then displayed, all while not interrupting the music. Further, when a slideshow of images is being presented on a main screen of a media presentation system, the user interface 300 may be accessed without interrupted the slideshow. Specifically, the slideshow may continue playing in the display section 310 of each page of the user interface 300. During the presentation of the slideshow (or an individual image), each of the features of the user interface 300 may be accessed and/or manipulated. Additionally or alternatively, such a slideshow or individual image may be presented in other on-screen guides that may be accessed by a user during such a presentation. For example, currently displayed slideshow may continue to play in a designated section (a section similar to the display section 310 of FIG. 3) when a program guide or picture-in-picture feature is activated and/or brought onto the screen. Further, music selected from the peripheral media storage device may be played while video is being played. For example, such a music file may be played during a television broadcast, the playback of recorded content, or playback of video from the peripheral media storage device (e.g., the same device on which the music resides). Such a process may involve muting the audio portion of a current video in lieu of music selected from the user interface 300.

While multiple types of media (e.g., music, video, and/or images) are being presented, the example user interfaces and methods described herein may allow a user to control either type of media with a single user interface and/or a single set of control keys (e.g., buttons on a remote input device). For example, an input device may include a single set of playback keys (e.g., play, pause, fast-forward, etc.) that may be used for any type of media via a control switching button on the input device. Accordingly, when music and images, for example, are simultaneously being presented, the set of input keys may be set to control the images (e.g., a slideshow that may be paused, fast-forwarded, reversed, etc.) and an engagement of the control switching button may cause the same set of input keys to be set to control the music (e.g., a song that may be paused, fast-forwarded, reversed, etc.). Further, as described above, the same user interface (e.g., the user interface 300 of FIG. 3) may be used to control various types of media during simultaneous presentations.

The user interface 300 may also implement a ‘Now Playing’ feature that allows a user to return to the context (i.e., the state of the user interface 300) from which the currently playing media was chosen. For example, where a user had selected a song from the list 802 of FIG. 8 and the song is currently playing from a main screen (e.g., a full-screen display dedicated to presenting music), engaging the ‘Now Playing’ feature may cause the media presentation system to display the screenshot of FIG. 8 and, perhaps, include a description and/or other data regarding the current song in the information section (e.g., the information section 306 of FIG. 3). The user may, for example, select a new or repeat song from the same category from which the current song was selected. The ‘Now Playing’ feature may operate in a similar manner for a current slideshow or set of images or videos.

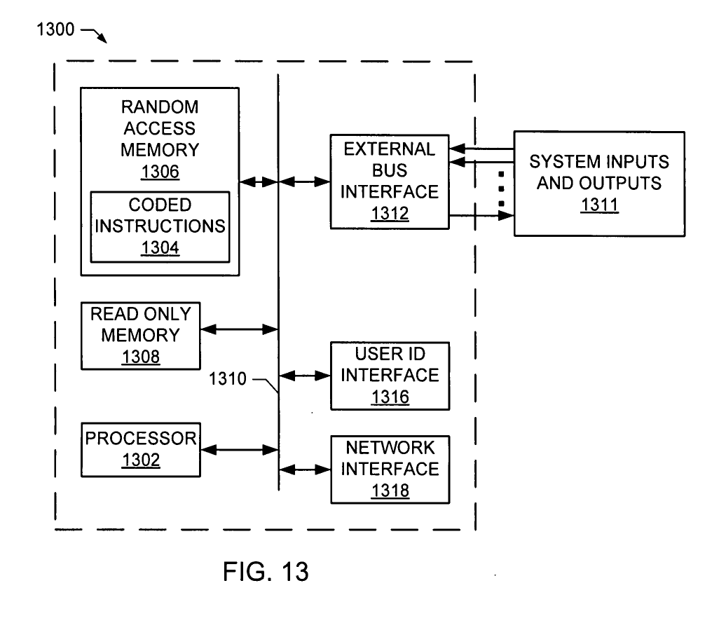

FIG. 13 is a schematic diagram of an example manner of implementing an example processor unit 1300 to execute the example methods and apparatus described herein. The example processor unit 1300 of FIG. 13 may be implemented within an IRD 130 and may include a general purpose programmable processor 1302. The example processor 1302 may execute, among other things, machine accessible instructions 1304 (e.g., instructions present within a random access memory (RAM) 1306 as illustrated and/or within a read only memory (ROM) 1308) to perform the example processes described herein. The example processor 1302 may be any type of processing unit, such as a microprocessor from the Intel® Pentium® family of microprocessors, the Intel® Itanium® family of microprocessors, and/or the Intel XScale® family of processors. The processor 1302 may include on-board analog-to-digital (A/D) and digital-to-analog (D/A) converters.

The processor 1302 may be coupled to an interface, such as a bus 1310 to which other components may be interfaced. The example RAM 1306 may be implemented by dynamic random access memory (DRAM), Synchronous DRAM (SDRAM), and/or any other type of RAM device, and the example ROM 1308 may be implemented by flash memory and/or any other desired type of memory device. Access to the example memories 1308 and 1306 may be controlled by a memory controller (not shown) in a conventional manner.

To send and/or receive system inputs and/or outputs, the example processor unit 1300 includes any variety of conventional interface circuitry such as, for example, an external bus interface 1312. For example, the external bus interface 1312 may provide one input signal path (e.g., a semiconductor package pin) for each system input. Additionally or alternatively, the external bus interface 1312 may implement any variety of time multiplexed interface to receive output signals via fewer input signals.

To allow the example processor unit 1300 to interact with a remote server, the example processor unit 1300 may include any variety of network interfaces 1318 such as, for example, an Ethernet card, a wireless network card, a modem, or any other network interface suitable to connect the processor unit 1300 to a network. The network to which the processor unit 1300 is connected may be, for example, a local area network (LAN), a wide area network (WAN), the Internet, or any other network. For example, the network could be a home network, an intranet located in a place of business, a closed network linking various locations of a business, or the Internet.

Although an example processor unit 1300 has been illustrated in FIG. 13, processor units may be implemented using any of a variety of other and/or additional devices, components, circuits, modules, etc. Further, the devices, components, circuits, modules, elements, etc. illustrated in FIG. 13 may be combined, re-arranged, eliminated and/or implemented in any of a variety of ways.

The apparatus and methods described above are non-limiting examples. Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

Although certain example methods and apparatus have been described herein, the scope of coverage of this patent is not limited thereto. On the contrary, this patent covers all methods and apparatus fairly falling within the scope of the appended claims either literally or under the doctrine of equivalents.

What is claimed is:

1. A user interface for use with a media presentation system comprising:
a main page and a plurality of pages operatively linked to the main page; and
one or more interactive sections to present information associated with one or more media files,
wherein the user interface integrates control over one or more presentations of media files of various formats from one or more media storage devices, and wherein the one or more media storage devices are peripheral devices in relation to the media presentation system.

2. A user interface as defined in claim 1, wherein the user interface enables a user to control a first presentation of a media file of a first format during a second presentation of a media file of a second format.

3. A user interface as defined in claim 2, wherein the media file of the first format is one of an audio file, an image file, or a video file, and the media file of the second format is one of an audio file, an image file, or a video file.

4. A user interface as defined in claim 2, wherein the media file of the first format and the media file of the second format are stored on the same media storage device.

5. A user interface as defined in claim 1, wherein the one or more media storage devices include one of a personal computer, a personal digital assistant, a camera, a telephone, or a mass storage device.

6. A user interface as defined in claim 1, further comprising a display section to display a presentation of content being presented prior to an activation of the user interface.

7. A user interface as defined in claim 6, wherein the display section presents a slideshow of images being presented prior to the activation of the user interface.

8. A user interface as defined in claim 1, wherein the one or more interactive sections include a menu section and a staging section.

9. A user interface as defined in claim 8, wherein contents of the staging section alter in response to a manipulation of the menu section.

10. A user interface as defined in claim 8, wherein the staging section includes a representation of content stored on the one or more media storage devices.

11. A user interface as defined in claim 8, wherein the menu section includes a plurality of categories corresponding to an organization of content stored on the one or more media storage devices.

12. A user interface as defined in claim 11, wherein a selection of one of the plurality of categories causes the staging section to display content of the selected category.

13. A user interface as defined in claim 1, further comprising a feature to return to a screen of the user interface from which a currently playing media file was selected.

14. A method for use with a media presentation system comprising:
displaying a main page of a user interface, including a menu section and a staging section, in response to an activation of the user interface;
displaying a plurality of navigation options in the menu section to represent an organization of content stored on a media storage device, wherein the media storage device is a peripheral device in relation to the media presentation system;
displaying content stored on the media storage device in the staging section in response to a selection of an option of the menu; and
presenting, via the media presentation system, content stored on the media storage device in response to a selection of the content from the menu section or staging section, wherein the user interface integrates control over one or more presentations of media files of various formats from the media storage device.

15. A method as defined in claim 14, further comprising controlling a first presentation of a media file of a first format during a second presentation of a media file of a second format.

16. A method as defined in claim 14, further comprising displaying a presentation of content being presented before the activation of the user interface in a display section positioned in the user interface.

17. A media presentation system comprising:
a display device;
a transmission system capable of generating and transmitting streams of audiovisual content;
a receiver capable of receiving audiovisual content and generating video and audio output signals to the display device;
a media storage device coupled to the receiver;
a means for presenting content stored on the media storage device through the display device via the receiver; and
a user interface to facilitate a control of a presentation of the content stored on the media storage device, wherein the user interface integrates control over one or more presentations of media files of various formats from one or more media storage devices.

18. A media presentation system as defined in claim 17, wherein the media storage device is a peripheral device in relation to the media presentation system.

19. A media presentation system as defined in claim 14, wherein the user interface enables a user to control a first presentation of a media file of a first format during a second presentation of a media file of a second format.

20. A media presentation system as defined in claim 15, further comprising an input device including a set of buttons to control a presentation of a media file, and a switching button to enable a user to control media files of various formats via the set of buttons.

21. An article of manufacture storing machine readable instructions which, when executed, cause a machine to:
display a main page of a user interface, including a menu section and a staging section, in response to an activation of the user interface;
display a plurality of navigation options in the menu section to represent an organization of content stored on a media storage device, wherein the media storage device is a peripheral device in relation to the media presentation system.
display content stored on the media storage device in the staging section in response to a selection of an option of the menu; and
present, via a media presentation system, content stored on the media storage device in response to a selection of the content from the menu section or staging section, wherein the user interface integrates control over one or more presentations of media files of various formats from the media storage device.

22. An article of manufacture as defined in claim 21, wherein the machine readable instructions, when executed, cause a machine to control a first presentation of a media file of a first format during a second presentation of a media file of a second format.

23. An article of manufacture as defined in claim 21, wherein the machine readable instructions, when executed, cause a machine to display a presentation of content being presented before the activation of the user interface in a display section positioned in the user interface.
